(19) United States
(12) Patent Application Publication
(10) Pub. No.: US 2014/0131377 A1
(43) Pub. Date: May 15, 2014

(54) Poop-up

(71) Applicant: Selma Rogers, Miami, FL (US)

(72) Inventor: Selma Rogers, Miami, FL (US)

(21) Appl. No.: 13/730,739

(22) Filed: Jun. 7, 2013

(30) Foreign Application Priority Data
Dec. 28, 2012 (US) 13730739

(51) Int. Cl. A01K 27/00

(52) U.S. Cl. CPC A01K 27/008
USPC 221/155; 119/797

(57) ABSTRACT

The concept of “POOP-UP” is a pet leash retractor with a reflective leash. This device would be similar in construction to a standard retractable leash, with spring-loaded retracting unit. The unit would measure approximately 9 to 10 inches long, 3 inches wide, and 6 inches high, with a rear handle and release trigger. However the leash itself would feature a reflective or glowing design. In addition the unit would feature a button storage chamber that could store a battery-operated waste bag dispenser. The dispenser with feature a window to allow the user to see when the bags need refilled, and would have a top activation that would allow user to easily dispense a single bag. To use the POOP-UP the owner would simply attach the leash to the Pets collar as normal. The owner could then take the pet for a walk at night while secure knowledge that he/she and the pet could be easily be seen by motorist, bicyclists, and other. pedestrians. In addition, the bag dispenser would make it easier to clean up after the pet. When necessary, the pet owner could simply press the button to dispense a bag from the unit, and utilize it to pick up and bag the waste. The waste could then be deposited into a receptacle.

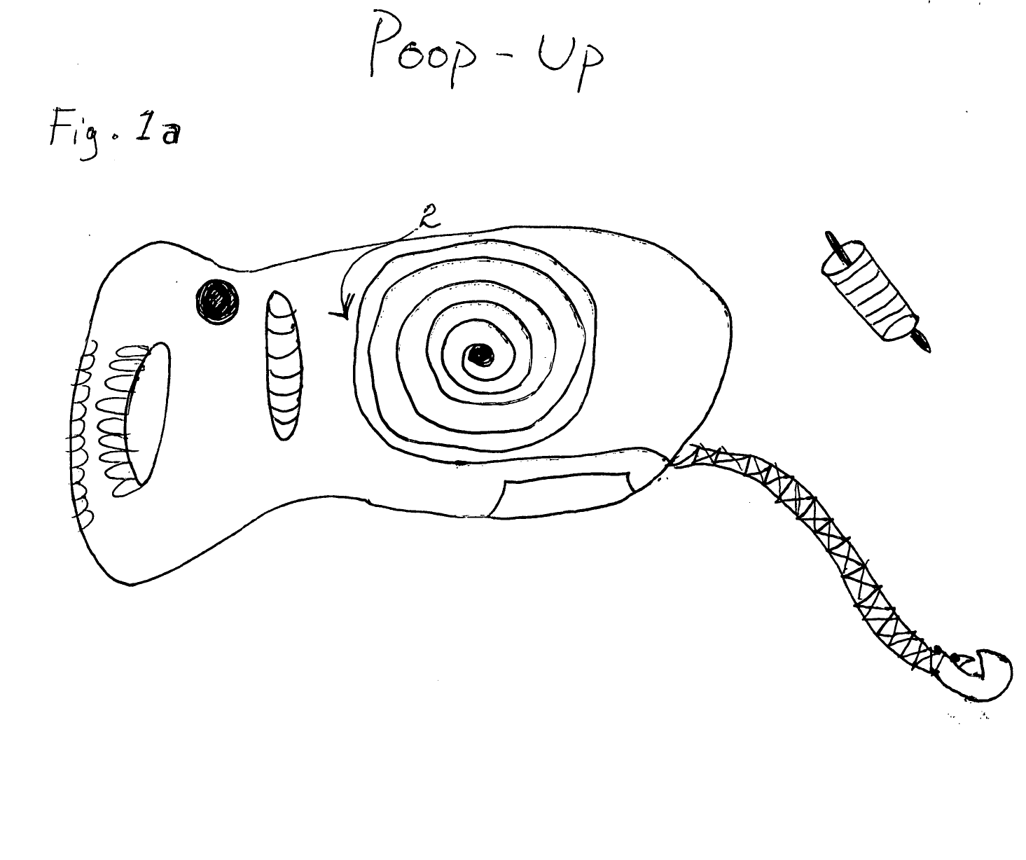

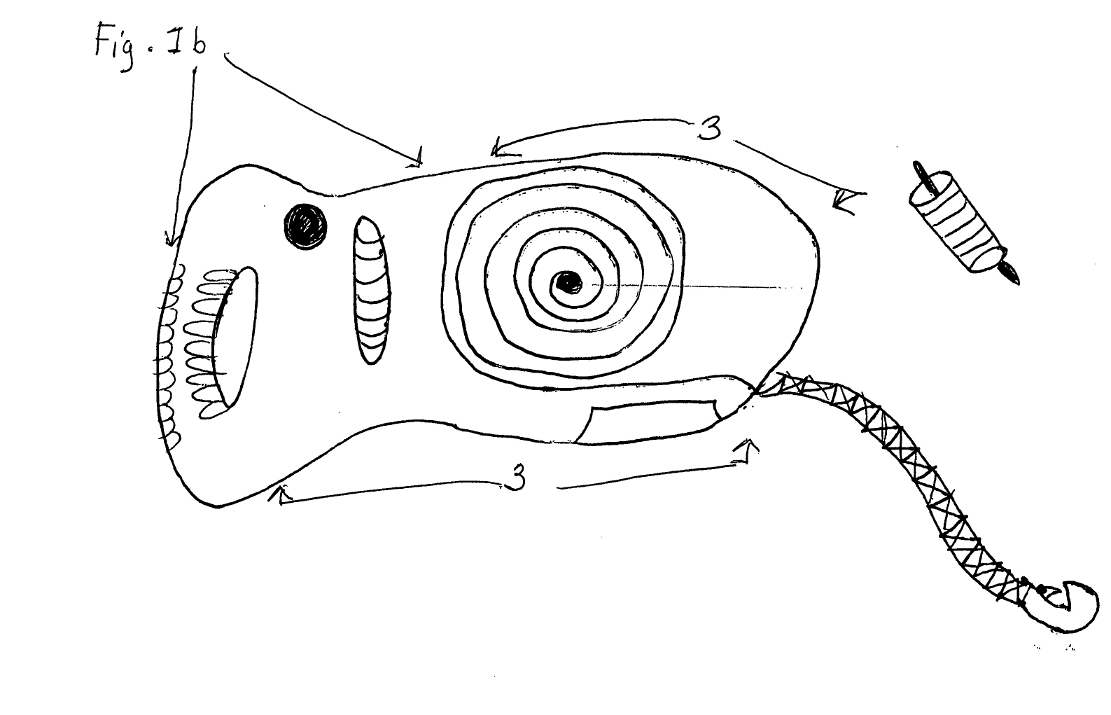

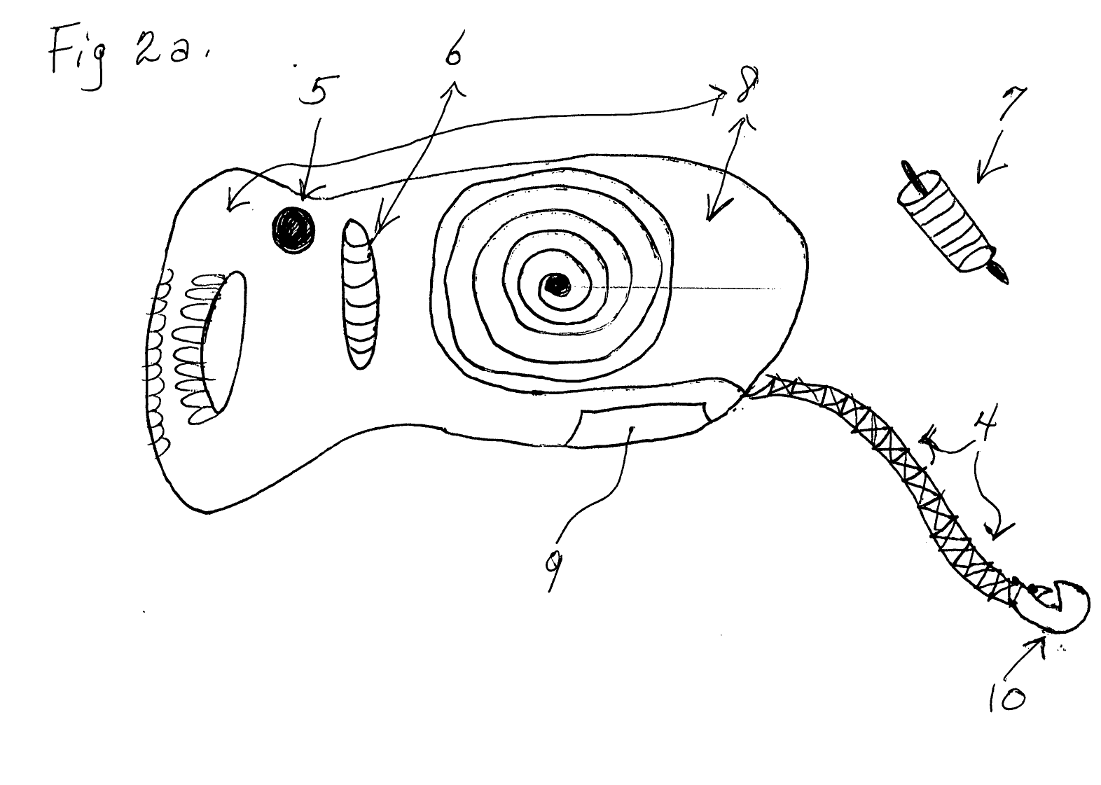

The (POOP-UP) up I was suggested by me (Selma Rogers). I believe it would fulfill the need for a Pet leash retraction device with a reflective leash and a built in bag dispenser. The appealing features of (POOP-UP) would be its safety, practically attractiveness, and durability. The concept of the (POOP-UP) is a pet leash retractor with a reflective leash. This device would be similar in construction to a standard retractable leash, with spring-loaded retracting unit. The unit would measure approximately 9 to 10 inches long, 3 inches wide, and 6 inches high, with a rear handle and release trigger. However the leash itself would feature a reflective or glowing design, in addition the unit would feature a button storage chamber that could store a battery-operated waist bag dispenser. The dispenser would feature a window to allow the user to see when bags need refilled, and would have a top activation that would allow users to easily dispense a single bag. To use the (POOP-UP) the owner would simply attach the leash to the

Pets collar as normal. The owner could then take the pet for walk at night with secure knowledge that he/she and the pet could be easily seen by motorist, bicyclist, and other pedestrians. In addition, the bag dispenser would make it easier to clean up after the pet. When necessary, the pet owner could simply press the button to dispense a bag from the unit, and utilize it to pick up and bag the waste. The waste could then be deposited into a trash receptacle.

### BRIEF DESCRIPTION OF DRAWING

1. Top activation for bags to dispense

1 (B). Unit would measure 9 to 19 inches long

2. The unit would measure 3 inches high

3. The unit would measure 3 inches wide

4. Refillable bags

5. Battery operated

6. Button storage chamber

7. Reflective leash

8. Pet clasp has a metallic hardware

9. Battery storage for (2) AA Batteries

10. The unit itself would be reflective or glowing.

What is claimed is:

1. A pet leash retractor, with a reflective leash, comprising:

2. This device would be similar in construction to a standard retractable Leash, with a string-loaded retracting unit.

3. The unit would measure approximately 9 to 10 inch long, 3 inches wide And 6 inches high, with a rear handle release trigger.

4. The leash itself would feature a reflective or glowing design.

5. In addition the unit would feature a button storage chamber that could Store a battery-operated waste bag dispenser.

6. The dispenser would feature a window to allow the user to see the bags Need refilled, and would have a top activation that would allow user to easily dispense a single bag.

7. There will also be extra refill bags to be used when the storage chamber Is empty.

8. The unit itself will be reflective for night vision.

9. Battery compartment stores two aa batteries

10. A pet leash clamp has a mettalic hardware component comprises A spring clip removeable attachment to said pet collar.

11. A reflective retractable pet leash as recited by claim 1, wherein said flat leash portion comprises nylon fibers.

12. A reflective retractable pet leash as recited by claim 1, wherein said Flat leash portion comprises polypropylene fibers.

13. A reflective retractable pet leashas recited by claim 1 wherein said reflective means comprises a flat reflective strip located on at least One side of said flat leash portion.

14. A reflective retractable pet leash as recited by claim Wherein said Reflective means comprises a flat reflective strip located on both said front and back of said flat leash portion

15. A reflective retractable pet leash as recited by claim 4 wherein said flat reflective strip is substainially coated with a conformal transparent polymeric abrasion resistant coating.

16. A reflective retractable pet leash as recited by claim 1, wherein said hardware component comprises a clasp appointed to be releaseably connected to a pet collar.

17. A reflective retractable pet leash as recited by claim 1, wherein said retractable housing device comprises reflective portions.

18. A reflective retractable pet leash as recited by claim 1, wherein reflective means is located on both said front and back sides of said flat leash portion and being operable to provide substantially omnidirectional reflectivity.

19. A reflective retractable pet leash as recited by claim 1, wherein said flat leash portion is appointed to retract entirely within said retractable housing device.

20. A process for manufacture of a reflective pet leash, comprising the steps of:
A) selecting a flat leash portion operable to sustain a substantial tensile forces having a front and back side;
B) weaving a reclective means within said flat leash portion being operable to provide reflectivity;
C) forming a pet leash with a reflectivity having a central section, a proximal end and a distal end;
D) attaching said proximal end of said pet leash to a reel member;
E) winding said reel member so that said proximal end becomes wrapped around said reel member and said central section of said pet leash is releasably spirally arranged within said internal chamber of said retractable housing;
F) inserting said distal end of said pet leash within said extension-retraction aperture, and
G) attaching said distal end of said pet leash to a hardware component operable with a pet collar , said pet leash engaging with said reel member and said extension leash to operate in retracted and extended positions; wherein said central section of said pet leash is releaseably spirally arranged within said internal chamber when said pet leash is in a retracted position and wherein said central section of said pet leash extends from said internal chamber and traverses said extension-rectraction aperture when said pet leash is in an extended position.
